(19) United States
(12) Patent Application Publication
(10) Pub. No.: US 2009/0317211 A1
(43) Pub. Date: Dec. 24, 2009

(54) NOTCH FORMING APPARATUS, BOOKBINDING APPARATUS AND BOOKBINDING SYSTEM

(75) Inventor: Norishige Kato, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/487,114

(22) Filed: Jun. 18, 2009

(30) Foreign Application Priority Data
Jun. 20, 2008 (JP) 2008-161500

(51) Int. Cl. B42C 9/00; B65H 39/00

(52) U.S. Cl. 412/37; 270/58.07

(57) ABSTRACT

A notch groove Va is formed at a spine section Sb of a sheet bundle Sa on which an adhesive is applied so as to include a large amount of the adhesive. Also, a plurality of times of notch forming operation is performed while changing positions of notches V in respect to one sheet S so as to form a plurality of the notch grooves Va.

This application is based on Japanese Patent Application No. 2008-161500 filed on Jun. 20, 2008, in Japanese Patent Office, the entire content of which is hereby incorporated by reference.

### TECHNICAL FIELD

The present invention relates to a notch forming apparatus to form a notch at an edge section of sheets configuring a sheet bundle outputted by execution of a job, a bookbinding apparatus and a bookbinding system which form the sheet bundle by accumulating the sheets on which the notches are formed, and form a booklet by bonding the sheet bundle with an adhesive.

### BACKGROUND

There are suggested various technologies to form the booklet wherein a sheet bundle is formed by stacking a plurality of sheets on which images are formed, and the sheet bundle and a coversheet are bonded with an adhesive. For example, in a bookbinding system having an image forming apparatus such as a copying machine and a printer, a plurality of sheets, on which images are formed by an image forming apparatus, are automatically stacked to form the sheet bundle, and the sheet bundle and the coversheet are bonded with an adhesive to form a booklet.

A commonly-used procedure to form the booklet by the above bookbinding system will be described. First, a plurality of sheets on which images are formed are accumulated and aligned to form a sheet bundle. Next, the adhesive is applied onto a spine of the sheet bundle accumulated and aligned. Then, a coversheet is conveyed and stopped at a predetermined position to bond the coversheet with the spine of the sheet bundle. As the above procedure, the plurality of sheets and the coversheet are incorporated and the booklet is formed.

FIG. 21 shows an example of a booklet configured with the sheet bundle and the coversheet.

FIG. 21a shows a state where the coversheet is not yet folded, and the FIG. 21b shows a state where the coversheet is folded. As FIG. 21a shows the sheet bundle Sa having a spine Sb on which the adhesive is applied is moved in an arrow direction to be bonded with the coversheet K so that the sheet bundle Sa is covered by the coversheet K in a U-shape. In a final configuration of the booklet, as FIG. 21b shows, a side edge section Se of the sheet bundle Sa is aligned to a side edge section Ke of the coversheet K.

Meanwhile, if the sheet bundle Sa and coversheet K, are bonded by simply applying the adhesive on the spine Sb of the sheet bundle Sa as it is, a sufficient adhesive force cannot be obtained between the sheet bundle Sa and the coversheet K resulting in a problem that falling off of some of sheets S from the booklet takes place.

To resolve the above problem, as FIG. 22 shows, a notch V is formed by a notch forming apparatus on the edge section of the sheet S. By stacking a plurality of the sheets S having the notch V which is formed on the edge section thereof, a notch groove Va is formed at the spine Sa of the sheet bundle Sa. For example, as FIG. 23b shows, a straight and vertical notch groove Va is formed (FIG. 23b shows a state of the sine Sb of the sheet bundle Sa observed from a X direction in FIG. 23a).

As above, by forming the notch V on the edge section of the sheet S by the notch forming apparatus, a space can be acquired between the spine Sb of the sheet bundle Sa and the coversheet K to which a large amount of the adhesive is charged so that the adhesive force between the sheet bundle Sb and the coversheet K is ensured. The technology to form the notch V on the edge section of the sheet S is disclosed in Patent Document 1: unexamined Japanese patent application publication No. 2001-261221. In the Patent document, a notch section forming device is disposed at a conveyance path of the sheet thereon having an image formed to form the notch V automatically on the edge of the sheet S as FIG. 22 shows.

Document 1: unexamined Japanese patent application publication No. 2001-261221

As described above, to ensure the adhesion force, it is preferred to form the notch V on the edge section of the sheet S as FIG. 22 shows, however if the number of the notches formed on a sheet are small, a sufficient adhesive can not be filled between the spine of the sheet bundle and the coversheet and as the result, a sufficient adhesion force between the sheet bundle and the coversheet cannot be ensured.

Therefore, a large number of the notch V per sheet is preferred. However, if the same number of notch forming sections, as the number of the notches to be formed on one sheet, have to be disposed for the notch forming apparatus, a large number of the notch forming sections have to be provided as the number of the notches increases, which causes increasing of size of the apparatus and complication of the apparatus.

An object of the present invention is to provide a notch forming apparatus, a bookbinding apparatus and a bookbinding system to form a booklet in a preferable bonding condition by forming a large number of notches on one sheet while preventing the apparatus from increasing in size and being complicated.

### SUMMARY

The notch forming apparatus reflecting one aspect of the present invention includes: a notch forming section to form a notch on the edge of the sheet configuring the sheet bundle outputted by execution of a job, a moving section to move a position of the notch to be formed by the notch forming section on the sheet, a control section to control at least the notch forming section and the moving section for performing multiple notch forming operation while moving the notch position in respect to one sheet.

Also, the bookbinding related to the present invention is provided with the notch forming apparatus and the bookbinding section to form a booklet by bonding the edge section of the sheet bundle with the adhesive, wherein the notches are formed on the edge section.

Also, the bookbinding system related to the present invention is provided with an image forming apparatus to form the image on the sheet, and the bookbinding apparatus for bookbinding using the sheets on which the images are formed by the image forming apparatus.

### BRIEF DESCRIPTION OF THE DRAWINGS

These and other objects, advantages and features of the invention will become apparent from the following description thereof taken in conjunction with the accompanying drawings in which:

FIG. 1 is a frame format of a bookbinding system provided with an image forming apparatus, a bookbinding apparatus, a booklet storing apparatus and an automatic document feeding apparatus;

FIG. 2 is a block diagram of a control system in the bookbinding system;

FIG. 3 is a central cross-sectional view of the bookbinding apparatus;

FIG. 4 is a cross-sectional view showing a sheet accumulating section of a sheet bundle storing section in an obliquely state;

FIG. 5 is a cross-sectional view showing a sheet accumulating section of a sheet bundle storing section in a vertical state;

FIG. 6 is a cross-sectional view of a sheet storing section, an application section, a coversheet supplying section, a cutting section, and a booklet forming section;

FIG. 7 is a perspective view of a vicinity of an application section;

FIGS. 8a, 8b, 8c and 8d are cross-sectional views of a booklet forming section and a sheet bundle, showing a folding process of a coversheet;

FIGS. 9a, 9b, and 9c are perspective views showing a forming process of a booklet using a sheet bundle and a coversheet;

FIG. 10 is a cross-sectional view of the notch section;

FIGS. 11a, 11b, 11c and 11d are plane views of sheets on which notches and through holes are formed;

FIG. 12 is a front view of a notch forming section and a moving section;

FIG. 13 is an explanatory diagram showing a setting screen for a notch forming process in an operation section.

FIG. 14 is a flow chart showing operation to form a notch based on number of operation times and a pitch set by a user;

FIG. 15a is a perspective view showing a sheet bundle in case the notch forming process is performed two times;

FIG. 15b is a front view of a spine of a sheet bundle in case the notch forming process is performed two times;

FIGS. 16a, 16b, 16c, 16d, and 16e are explanatory diagrams showing patterns of notch grooves formed on sheet bundles;

FIG. 17 is an explanatory diagram of patterns of notch grooves displayed on an operation section for user selection;

FIG. 18 is an explanatory diagram showing other patterns of notch grooves formed on a sheet bundle;

FIGS. 19a, 19b and 19c are explanatory diagrams showing setting screens of an operation section to input the pattern of the notch groove;

FIGS. 20a, 20b and 20c are explanatory diagrams showing notches having different notch depths;

FIGS. 21a and 21b are perspective views showing a booklet configured with a sheet bundle and a coversheet;

FIG. 22 is an explanatory diagram of a sheet having an edge on which notches are formed; and

FIGS. 23a and 23b are explanatory diagrams showing notch grooves formed on a spine of a sheet bundle.

### DETAILED DESCRIPTION OF PREFERRED EMBODIMENTS

<Outline of the Bookbinding System>

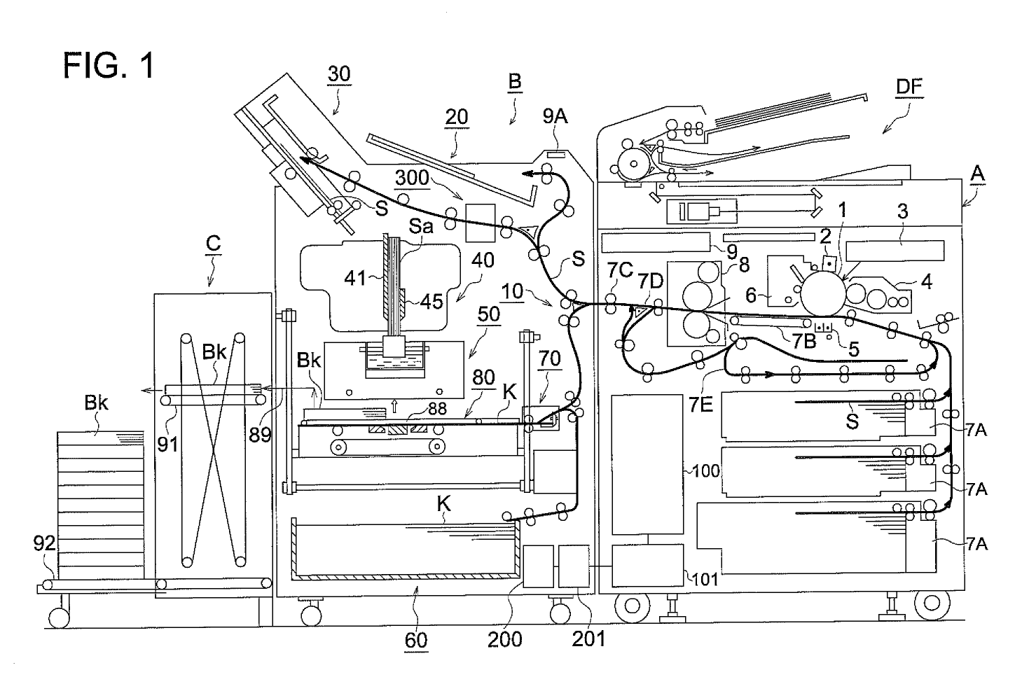

FIG. 1 is a frame format of a bookbinding system provided with an image forming apparatus, a bookbinding apparatus, a booklet storing apparatus and an automatic document feeding apparatus.

The image forming apparatus A is provided with an image forming section having a charging section 2, an imagewise exposing section 3, a developing section 4, a transfer discharging section 5, and a cleaning section 6 in a periphery of a rotating image carrier 1. The image forming section charges a surface of the image carrier 1 by the charging section 2, and thereafter performs exposure scanning based on image data read out from a document through a laser beam of the imagewise exposure section 3 so as to form a latent image. Then, a toner image is formed on a surface of the image carrier 1 by developing the latent image through the developing section 4.

The sheet S fed from the sheet storing section 7A is conveyed to a transfer position on the image carrier 1. At the transfer position, after the toner image is transferred onto the sheet S, the surface of the sheet S is discharged by the transfer discharging section 5 so that the sheet S is separated from the image carrier 1 and conveyed through a conveyance section 7B. Thereafter, the toner image on the sheet S is fixed on the sheet S by a fixing section 8, and the sheet S is ejected from the image forming apparatus A through the sheet ejection rollers 7C.

In case images are formed on both sides of the sheet S, the sheet S having been subject to heat fixing by the fixing section 8 is diverged from a sheet ejection path by a conveyance path changeover section 7D, and turned over upside down by switchback in a reversal conveyance section 7E. Then sheet S is conveyed to the image forming section again so as to form an image on a reverse side of the sheet S. The sheet S ejected through the sheet ejection roller 7C is sent to the book binding apparatus B.

On an upper part of the image forming apparatus A, there is disposed an operation section 9 through which contents of a job to be executed in the bookbinding system is inputted by a user.

As FIG. 1 shows, a book binding apparatus B is a case binding apparatus having a conveyance path 10, a sheet ejection section 20, a reversal section 30, a sheet bundle storing section 40, a application section 50, a coversheet supply section 60, a cutting section 70, and booklet forming section 80 and so forth. Meanwhile, besides the case binding apparatus, the present invention can be applied to a gluing book binding apparatus which simply bonds the sheet bundle with the adhesive.

<Block Diagram of Bookbinding System>

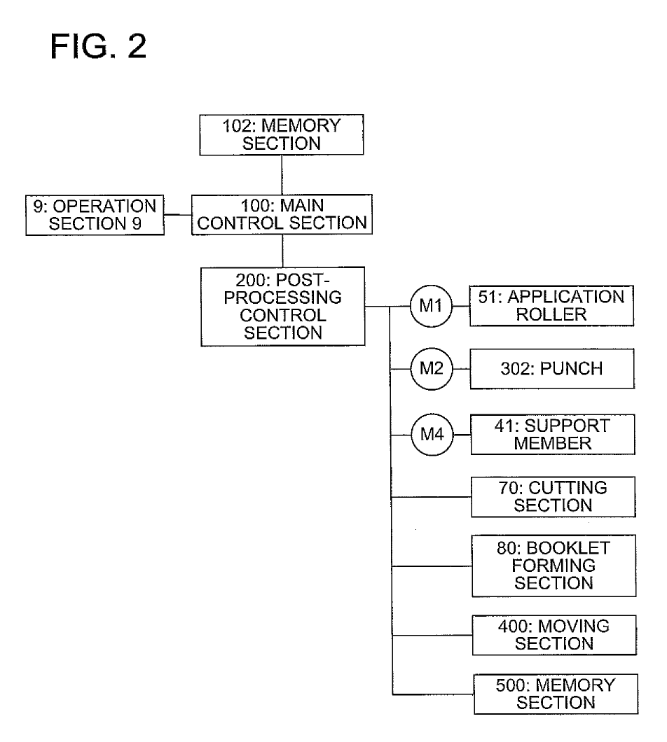

FIG. 2 is a block diagram of a control system in the bookbinding system showing typical components herein. A main control section 100 of the image forming apparatus A, and a post-processing apparatus 200 of the bookbinding apparatus B are connected via serial communication sections 101 and 201 (Refer to FIG. 1). By a command of the main control section 100, the post-processing control section 200 controls each section of the bookbinding apparatus B. Meanwhile, in the present embodiment, the post processing control section 200 serves as a control section.

To the main control section 100, a memory section 102 is connected in which pattern information indicating a position of the notch V is stored.

To form a booklet, the post-processing control section 200 controls drive of each section to be described. The post-processing control section 200 controls a motor M1 to drive an application roller 51, a motor M2 to drive a punch 302 of the notching section 300, a motor M4 to drive a supporting member 41 to support the sheet bundle, and a moving section 400 to drive a cutting section 70, a booklet forming section and a notching section 300. The memory section 500 stores data received by the bookbinding apparatus B from the image forming apparatus A and the post-processing apparatus 200 controls the motor M1 and the motor M2 based on the stored data.

<Outline of Bookbinding Apparatus>

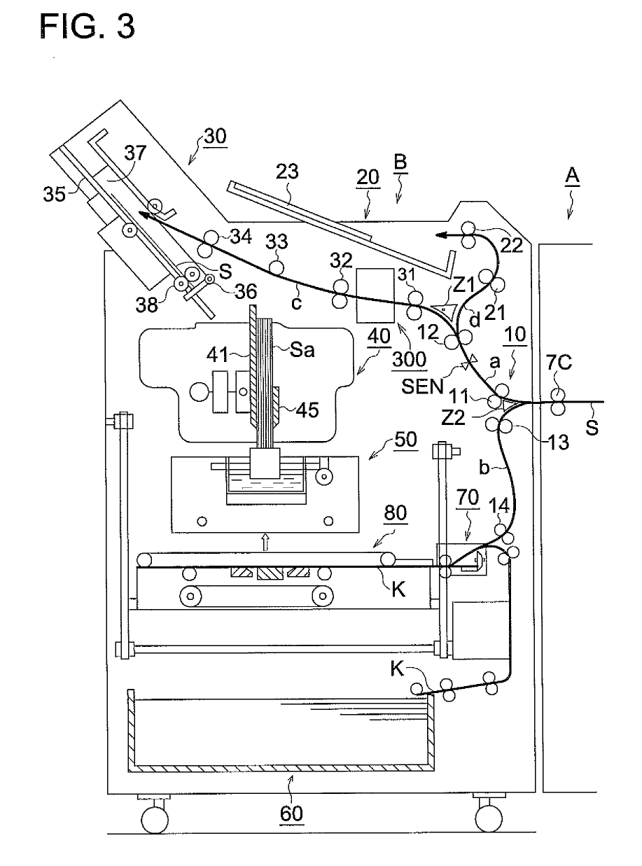

FIG. 3 is a central cross-section of the bookbinding apparatus B. A conveyance path changeover section Z2 disposed at an upstream side of the conveyance roller 11 in a sheet conveyance direction delivers the sheet S to a conveyance path a or a conveyance path b. The sheet S led to the conveyance path a is grasped by the conveyance rollers 11 and 12 to be conveyed and branched to the sheet ejection section 20 or the reversal section 30 through the conveyance path changeover section Z1. The sheet S conveyed to the conveyance path b is grasped by the conveyance rollers 14 to be sent to a booklet forming section 80 which serves as a bookbinding section. At the conveyance path a, a sheet detecting sensor SEN is disposed to detect the sheet S conveyed in the conveyance path a.

To eject the sheet S to a sheet ejection section 20, the conveyance path changeover section Z1 interrupt a conveyance path c to sheet bundle storing section 40 and opens a conveyance path d to sheet ejection section 20. The sheet S passing through the conveyance path d to the sheet ejection section 20 is grasped by the conveyance rollers 21 to be conveyed upward, and ejected to a fixed sheet ejection tray 23 at an uppermost part of the apparatus through ejection rollers 22.

The sheet S branched to the conveyance path c by the conveyance path changeover section Z1 is grasped by rollers 31, 32, 33 and 34 to be stored at a predetermined position in the reversal section 30. The reversal section 30 is provided with a sheet loading table 35 obliquely disposed, a registration member 36 to register a sheet rear edge, an aligning member 37 to align the sheet S in a sheet width direction, a conveyance roller 38 and so forth.

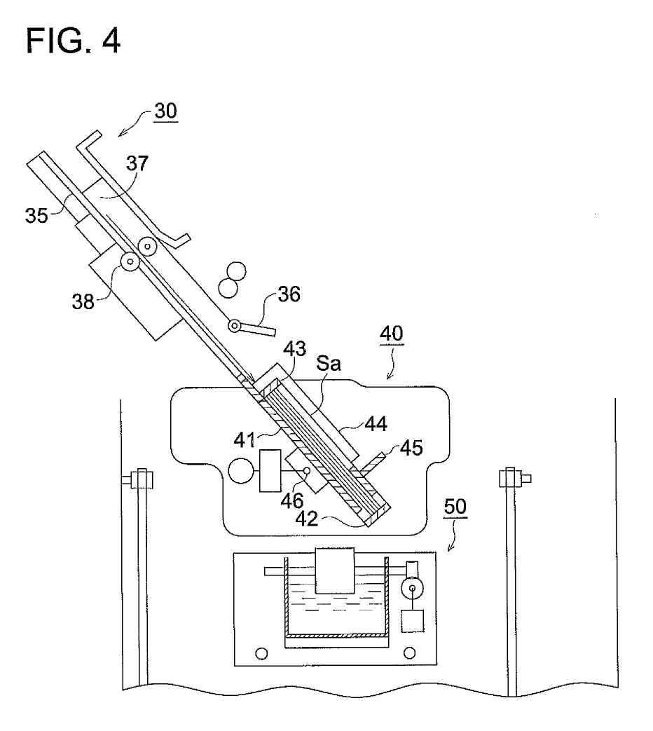

FIG. 4 is a cross-sectional view showing a state where the sheet accumulating section in the sheet bundle storing section 40 is tilted. The sheet bundle storing section 40 is provided with a supporting member 41, a receiving plate 42, a lateral aligning member 44 and an imposing member 45.

The sheet S placed on the sheet placing table 35 in the reversal section 30 is grasped by the conveyance rollers 38 to be ejected from an opening opened by swing of a positioning member 36 and conveyed downward obliquely. The sheets S are successively accumulated in the sheet bundle storing section 40.

The sheet bundle storing section 40 is provided with a supporting member 41 having an oblique accumulation surface and a receiving plate 42 to be able to swing. The sheet S descended from the reversal section 30 slides down the accumulation surface of the oblique supporting member 41, and stops by contacting the front edge section of the sheets S to the receiving plate, then the sheet S is supported in an oblique state. The lateral aligning member 43 press a rear edge of the sheet S in accordance with the size of the sheet S placed on the accumulating surface of the supporting member 41 so that the front edge section of the sheet S comes in contact with the receiving plate 42. Thereby the front edges of the sheets S are aligned. The sheet S successively ejected form the image forming apparatus A is conveyed by switchback in the reversal section 30 and accumulated in the sheet bundle storing section 40. Thereby a sheet bundle Sa configured with a plurality of sheets S are formed.

A size and number of sheets in the sheet bundle Sa representing setting conditions of the booklet formed by the bookbinding apparatus B can be set by the operating section 9 of the image forming apparatus A or by an external equipment such as a personal computer connected with the image forming apparatus A.

The lateral aligning member 44 performs lateral aligning in the sheet width direction by pressing the side edges of the sheets S conveyed form the reversal section 30 and stored in the sheet bundle storing section 40.

The imposing member 45 presses the sheet bundle Sa accumulated in the sheet bundle storing section 40 in a thickness direction of the sheet bundle Sa to grasp them. At a stage where a set number of the sheets S are stored in the sheet bundle storing section 40, the imposing member 45 is operated by an unillustrated motor so that the sheet bundle Sa is grasped between the supporting member 41 and the imposing member 45.

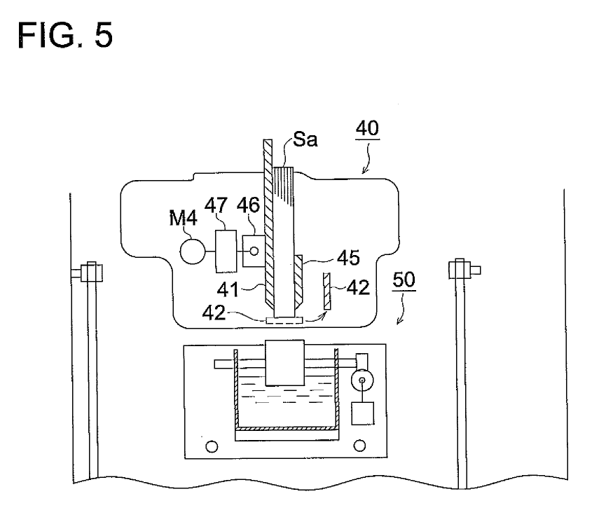

FIG. 5 is a cross-sectional view showing the sheet accumulating section of the sheet bundle storing section 40 in a vertical state.

The supporting member 41 and the imposing member 45 grasping the sheet bundle Sa rotate centering around an axis 46 of the sheet bundle storing section 40 by the motor M4 and a drive section 47 so that the sheet bundle Sa becomes the vertical state from the oblique state. In the state, a bottom surface of the sheet bundle Sa is detached from the application roller 51 of the application section 50. Also, in a state where the supporting member 41 and the imposing member 45 grasp the sheet bundle Sa, the receiving plate 42 rotates from a broken lines position to a solid line position in the figure by the unillustrated drive section.

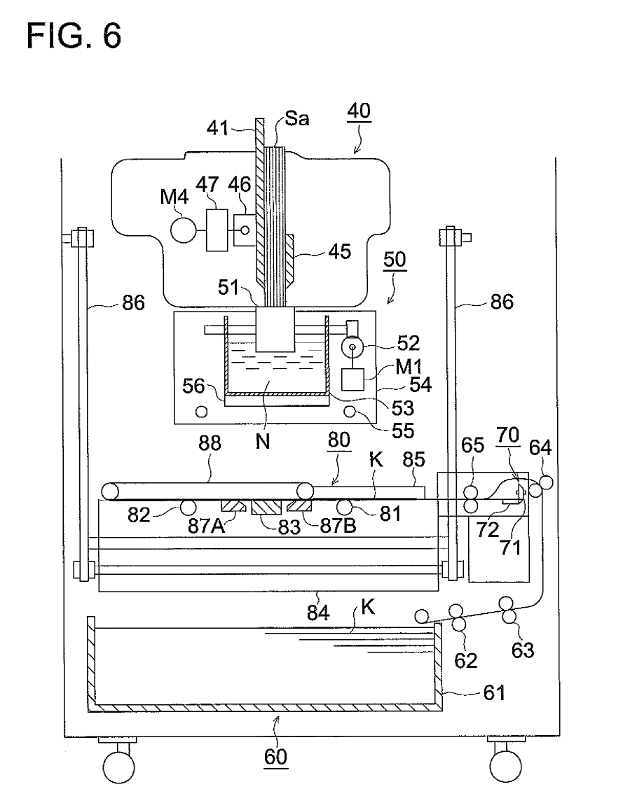

FIG. 6 is a cross-sectional drawing of the sheet bundle storing section 40, the application section 50, the coversheet supply section 60, the cutting section 70 and the booklet forming section 80.

The application section 50 is provided with an application roller 51, a drive section 52 to drive and rotate the application roller 51, an adhesive container 53 to contain an adhesive N such as glue, a moving body 54 to support and move the adhesive container 53 from an initial position at a back side of the bookbinding apparatus B to an application position at a front side, a moving device 55 to reciprocate the moving body 54, and a heating section 56 to head the adhesive N contained in the adhesive container 53.

The moving body 54 in the application section 50 moves in a direction parallel to a longitudinal direction of the bottom surface of the sheet bundle Sa held in the vertical state by the supporting member 41 and the imposing member 45.

The moving body 54 starts to move from the initial position at the back side of the bookbinding apparatus B and moves along the moving device 55, then stops at a predetermined position at a front side of the bookbinding apparatus B, thereafter returned to the initial position by reversal drive.

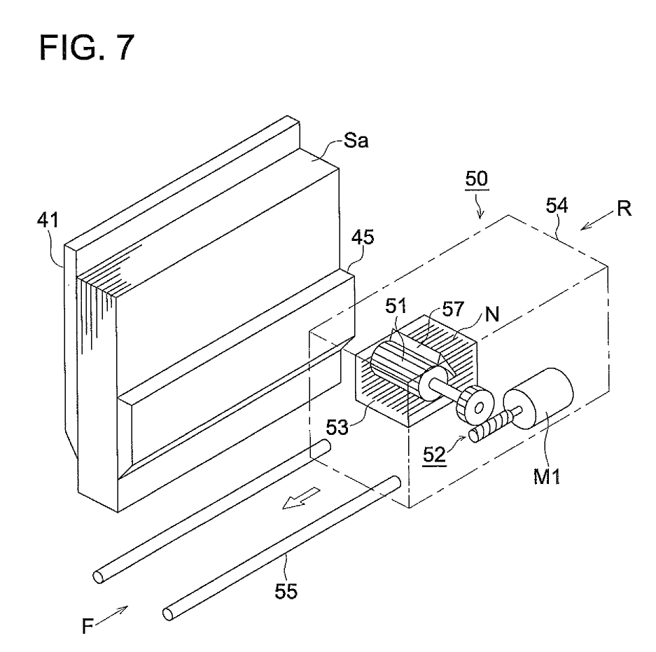

FIG. 7 is a perspective view of a vicinity of the application section 50.

The application roller 51 immersed in the adhesive N contained in the adhesive container 53 is rotated by the motor M1 and the drive section 52. The application roller 51 applies the adhesive N from a back side R to a front side F in the longitudinal direction on the bottom surface of the sheet bundle Sa grasped in a vertical state by reciprocation or by a forward stroke of the moving body 54.

The adhesive N applied on a circumferential surface of the application roller 51 is regulated in a thickness by a regulation member 57.

As FIG. 6 shows, the coversheet K stored in a coversheet stacking section 61 of the coversheet supply section 60 is separated and fed by the sheet feeding section 62 and grasped by the conveyance rollers 63, 64 and 65 to be conveyed to the booklet forming section 80.

The cutting section 70 configured integrally with the booklet forming apparatus 80 on a right side above the coversheet supply section 60 in the figure cuts the coversheet K in a predetermined length in the feeding direction with a rotary cutter configured with a rotation blade 71 and fixed blade 72.

The predetermined length is a length of two sheets in traveling direction of sheet S plus a width of the spine of the sheet bundle Sa. For example, in case of the case binding where the coversheet K is bonded onto a spine of the sheet bundle Sa configured with sheets S in A4 size, supposing that maximum number of the sheet in the sheet bundle Sa is 300 pieces and a thickness is 30 mm, the predetermined length is set to be 450 mm which is a two times length of short side of the A4 sheet 210 mm plus a thickness of the sheet bundle Sa of 30 mm, thus the coversheet K is cut in the above length (a total length of the coversheet K before cut is not less than 450 mm).

In case of the booklets are formed respectively with the sheets S having sizes of A5, B5, and 8.5×11 inches by case binding, the predetermined lengths are set based on the short side lengths of the sheets and the thicknesses of the sheet bundles.

When the sheet size, the number of the sheets, and the thickness of the sheet are set or detected though the control section 9 of the image forming apparatus A or the external equipment, the control section sets a cutting length of the coversheet K. The length of the coversheet K before cutting is determined in accordance with a maximum number of the sheets and stored in a coversheet stacking section 61 of the coversheet supply section 60.

The booklet forming section 80 to receive and convey the coversheet K supplied form the coversheet supply section 60 is provided with conveyance rollers 81 and 82 to stop the sheet at a predetermined position, the pressure member 83 to impose the coversheet K on an adhesive application surface of the sheet bundle Sa, a movable housing 84 to support the conveyance rollers 81 and 82, and the pressure member 83, and an elevating section 86 to enable the aligning section 85 and the movable housing 84 to move vertically.

The booklet forming section 80 and the booklet ejection belt 88 are elevated integrally by the elevating section 86. When the booklet forming section 80 descends and stops at a descent position to introduce the coversheet K, the aligning section 85 moves in accordance with the size of the coversheet K from an initial position and presses the both side surfaces of the coversheet K in the width direction to perform alignment before the cutting process. The sheet K having been subject to aligning in a width direction to correct a skew is switched back in a direction opposite to an introducing direction and conveyed to the cutting section 70 to be cut at a predetermined position.

Also, before the booklet forming section 80 bonds the coversheet K having been cut onto the spine of the sheet bundle Sa at the descent position, the aligning section 85 again moves from the initial position and performs width aligning by pressing both side surfaces of the coversheet K in the width direction to stop the sheet K at a predetermined position. Thereafter, the aligning section 85 returns to the initial position so that the aligning section 85 does not interfere bonding of the coversheet K and the sheet bundle Sa, then subsequently, the booklet forming section 80 ascends. When the booklet forming section 80 ascends, the coversheet K is supported at a predetermined position.

Therefore, the aligning section 85 disposed at the booklet forming section 80 to be capable of hoisting, aligns a position of the coversheet K in the coversheet width direction before and after the cutting section 70 cuts the coversheet, thereby enhancing a cutting accuracy of coversheet. Thus an aligning accuracy of the sheet bundle Sa and the coversheet K, and simplification of configuration can be attained.

The hoisting section 86 moves the moving housing 84 upward by rotating the left and right belts. In the ascent position, a center portion of the coversheet K placed on the pressure member 83 comes in pressure contact with the adhesive application surface of the sheet bundle Sa to be bonded. After application of the adhesive onto the sheet bundle Sa, the application section 50 moves backward to be retracted.

At an upper part of the booklet forming section 80, a coversheet folding section is equipped. The coversheet folding section has a pair of bilaterally symmetric forming members 87A and 87B. The forming members 87A and 87B are attached to and detached from the sheet bundle Sa in a thickness direction of the sheet bundle Sa. The forming members 87A and 87B fold the coversheet K along a side edge of the adhesive application surface of the sheet bundle Sa so that an obverse coversheet and a reverse coversheet lap the front and back surface of the sheet bundle Sa.

After the folding process of the coversheet K, the booklet forming section 80 descents by a predetermined distance to be retracted and stopped by descent drive of the hoisting section 86. Thereafter, when the grasping section releases grasping, the booklet Bk falls and the spine representing the bottom surface of the booklet Bk comes to contact with an upper surface of the booklet ejection belt 88, then the booklet Bk is loaded and ejected.

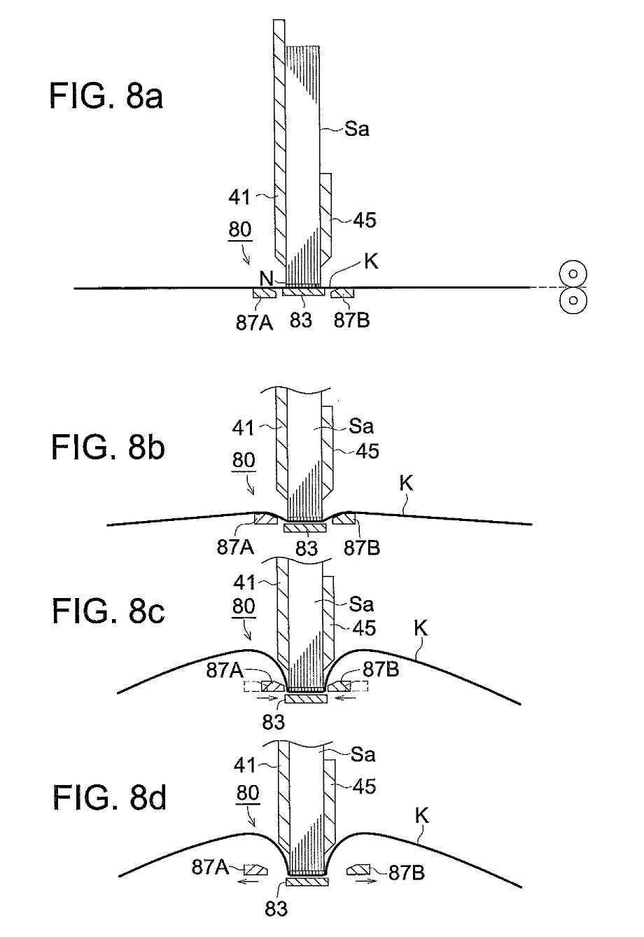

FIGS. 8a, 8b, 8c, and 8d are cross-sectional views of the booklet forming section 80 and the sheet bundle Sa showing the folding process of the coversheet K. FIG. 8a shows a start of coversheet folding, FIG. 8b shows a mid-course of coversheet folding, FIG. 8c shows an end of coversheet folding and FIG. 8d shows a state where a coversheet folding pressure is released.

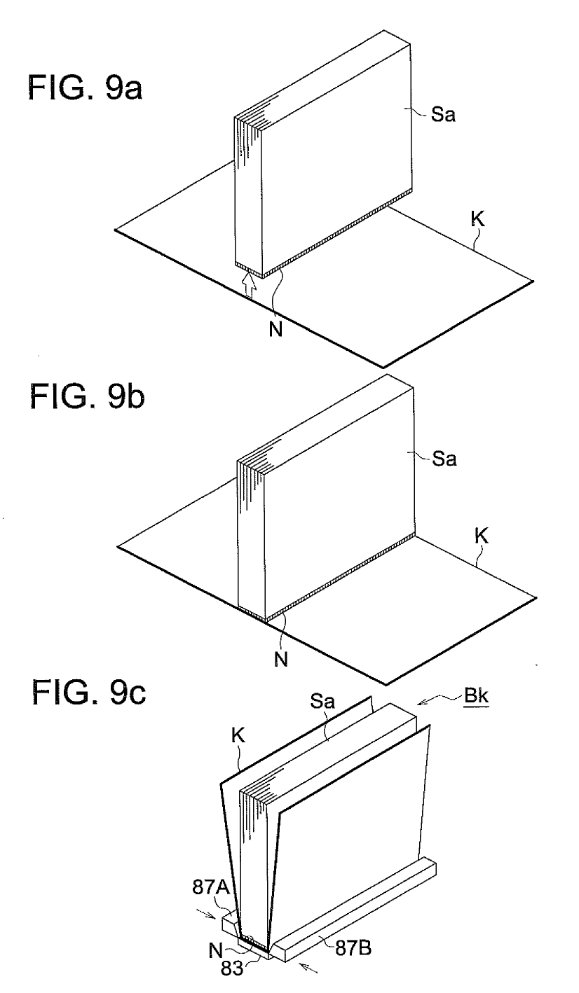

FIGS. 9a, 9b and 9c are perspective view showing a forming process of the booklet Bk using the sheet bundle Sa and the coversheet K. FIG. 9a is a perspective view of the coversheet K and the sheet bundle Sa before bonding process of the coversheet. FIG. 9b is a perspective view of the sheet bundle Sa to which to the coversheet K is bonded. FIG. 9c is a perspective view of the booklet Bk to be formed where the sheet bundle Sa is case bound with the coversheet K.

After the coversheet K is bonded with the sheet bundle Sa to which the adhesive N has been applied, in an ascent state of the booklet forming section 80 shown by FIG. 8a, the forming members 87A and 87B are driven by a drive section (unillustrated). The coversheet K is deformed from the side edge section of the adhesive application surface of the sheet bundle Sa while being grasped by the forming members 87A and 87B (Refer to FIG. 8b). Thereafter, the forming members 87A and 87B move horizontally towards the adhesive application surface of the sheet bundle Sa, and press both side surfaces of the sheet bundle Sa for shaping so as to form the booklet Bk.

<Outline of Notching Section>

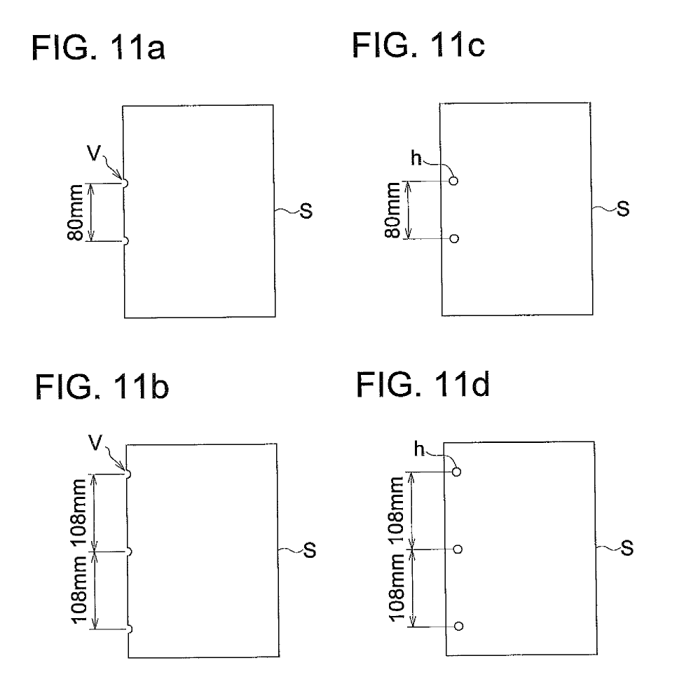

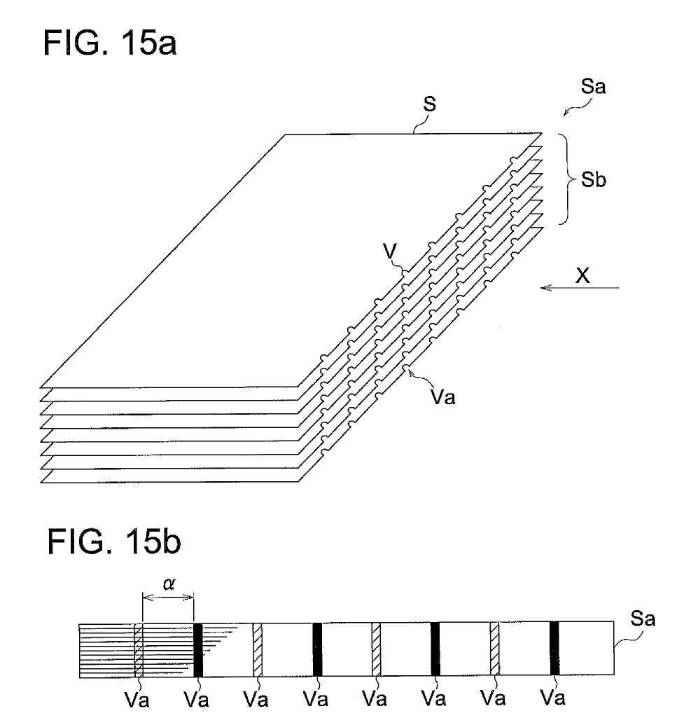

To enhance the adhesive force between the sheet bundle Sa and the coversheet K, the notch groove Va (Refer to FIG. 15) configured with notch V (Refer to FIG. 11) is formed on the spine of the sheet bundle Sa.

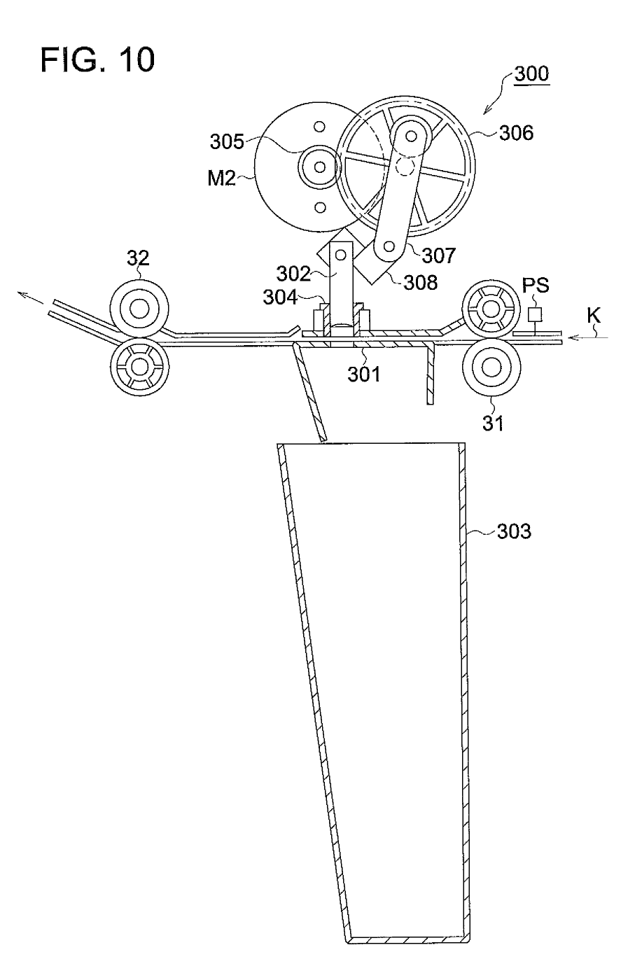

FIG. 10 is a cross sectional view of a notching section 300. The notching section 300 is provided with a die 301 which is fixedly arranged on a conveyance path of the sheet S, a punch 302 which rises and falls and engages with the die 301, a drive part for rising and falling the punch 302, and a scrap accommodation box 303 for accommodating the notch sheet scrap generated at notching process (being a process to form a notch at an edge part of the sheet S, and a notch forming motion in the present invention).

The outer peripheral surface of the punch 302 opposite to the die 301 is engaged with the inner surface of a guide member 304 in a manner that it can rise and fall. The drive part for rising and falling the punch 302 is configured with the motor M2, a small gear 305 connected to the motor M2, a large gear 306 engaged with the small gear 305, a crank 307 which is engaged on one end of the large gear 306 and can be swingy rotated, a linking member 308 for linking the crank 307 and the upper part of the punch 302. By the drive of the motor M2, the punch 302 is driven up and down through the small gear 305, the large gear 306, the crank 307, and the linking member 308. By the descending drive of the punch 302 and the engagement with the die 301, the notch V (refer to FIG. 11) is formed in the edge part of the sheet S.

FIG. 11 is a plan view of the sheet S in which the notch and the punched hole are formed.

For the shape of the notch V formed in the edge part of the sheet S, shapes such as a V-letter shape, and a U-letter shape, other than the illustrated semi-circle, are used. For example, the notch V can also be formed by the punch and die used for ordinary sheet file.

The number of the notches V and the punched holes h can be optionally set by regulating the number of the punches and the dies. Each of the two notches V shown in FIG. 11a has the hole diameter φ of 6 mm, and the hole pitch therebetween is 80 mm; and each of the three notches V shown in FIG. 11b has the hole diameter φ of 6 mm, and the hole pitch therebetween is 108 mm. Further, each of the two circular punched holes h shown in FIG. 11c has the hole diameter of 6 mm, and the hole pitch therebetween is 80 mm; and each of the three punched holes h shown in FIG. 11d has the hole diameter φ of 6 mm, and the hole pitch therebetween is 108 mm.

In the operation section 9 of the image forming apparatus A, in case where punching process and notching process are not set, the sheet S discharged from the image forming apparatus A passes through the notching section 300 without being processed, and coating process of the adhesive agent is conducted.

In the operation section 9, in case where the notching process for forming the notch V is set, the trailing edge part of the sheet S is detected by a sensor PS (refer to FIG. 10), after which, the number of pulses, which are larger than predetermined number of pulses which are made when the punch hole h are punched, are counted, and then, the sheet S is conveyed and is stopped, after which the notches V are formed in the vicinity of the edge part of the trailing edge part of the sheet S (refer to FIG. 11a and FIG. 11b).

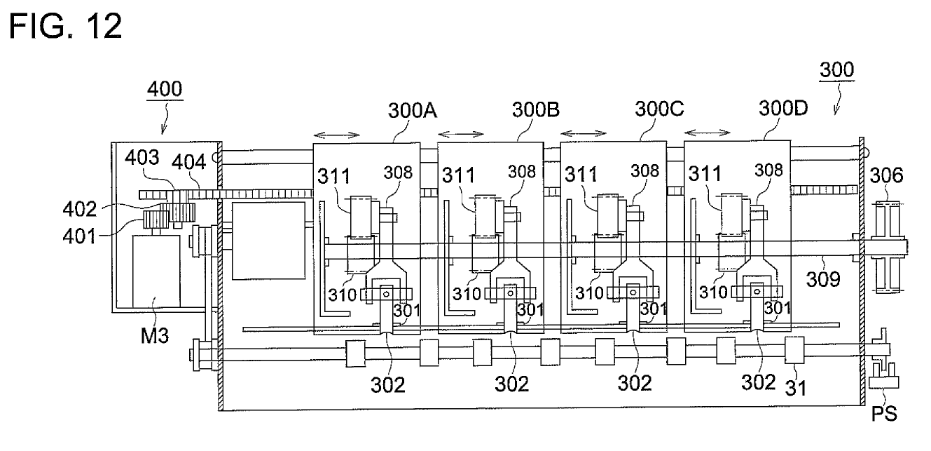

In the operation section 9, in case where the punching process for punching the circular punched hole h is set, the passing of the trailing edge part of the sheet S, which is conveyed with being nipped by the conveyance roller 31 and the conveyance roller 32, is detected by the sensor PS (refer to FIG. 10 or FIG. 12), after which, the predetermined pulses are counted and the drive of the motor for sheet conveyance (not illustrated) is stopped, and the advancing of the sheet S is stopped. At this sheet stop position, punch holes h are formed in the vicinity of edge part of the trailing edge part of the sheet S (refer to FIGS. 11c and 11d).

FIG. 12 is a front view of the notching section 300 and the moving section 400.

The moving section 400 moves the notch forming sections 300A, 300B, 300C and 300D, each of which has the punch 302 and the die 301, in the right and left direction in FIG. 12 (in the horizontal direction orthogonal to the sheet S conveyance direction), and by the notch forming sections 300A, 300B, 300C and 300D being moved in the right and left direction, positions of notches V formed in the sheet S are changed.

When the motor M3 is driven, a rack gear 404 is moved in the right and left direction in FIG. 12 through a gear train composed of gears 401, 402, and 403. In the rack gear 404, the notch forming sections 300A, 300B, 300C and 300D are engaged, and by the movement of the rack gear 404, the notch forming sections 300A, 300B, 300C and 300D are moved in the right and left direction in FIG. 12. In FIG. 12, four notch forming sections are shown, but the number of the notch forming sections can be optionally arranged depending on the number of the notch sections or the punch holes which is desired to be made on the sheet S. In the present embodiment, the notch forming apparatus is configured with the post processing control part 200, the notch forming sections 300A, 300B, 300C and 300D, and the moving section 400.

[Notching Process Setting]

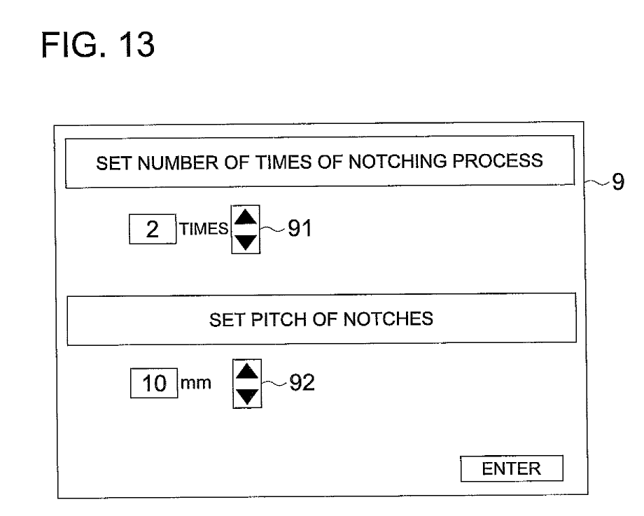

FIG. 13 is an explanatory figure indicating a setting screen of the notching process in the operation section 9. In case where a job of booklet production using the bookbinding system shown in FIG. 1 is carried out, a user can set up the number of times of the notching process and a pitch of the notch V using the operation section 9 at a time of setting up job content.

As shown in FIG. 12, since the notching section 300 has four notch forming sections 300A, 300B, 300C and 300D, four notches V are formed on a piece of sheet S in one notching process. Therefore, if a user wants to form the number of notches V more than four on a piece of sheet S, the number of times of the notching process can be increased by using a button for changing the number of times 91 in the operation section 9 as shown in FIG. 13. For example, when the number of times of the notching process is two, eight notches V are formed at different positions for one piece of sheet S.

If a user wants to densely form the notches V, the pitch between the notches V (α in FIG. 15) can be set by using a pitch changing button 92 in the operation section 9 as shown in FIG. 13. As stated above, since a user can optionally set up the number of times of the notching process or the pitch between the notches V, the apparatus gives high convenience for the user. Though it is not displayed in the operation section 9 shown in FIG. 13, by changing the number of times of the notching process, the number of notches V formed on one piece of sheet S may be allowed to be displayed on the operation section 9.

[Control Motion of Notching Process]

Next, a motion will be explained in which settings such as the number of times of the notching process are carried out at the operation section 9, and the notches V are formed on the sheet S at the bookbinding apparatus B.

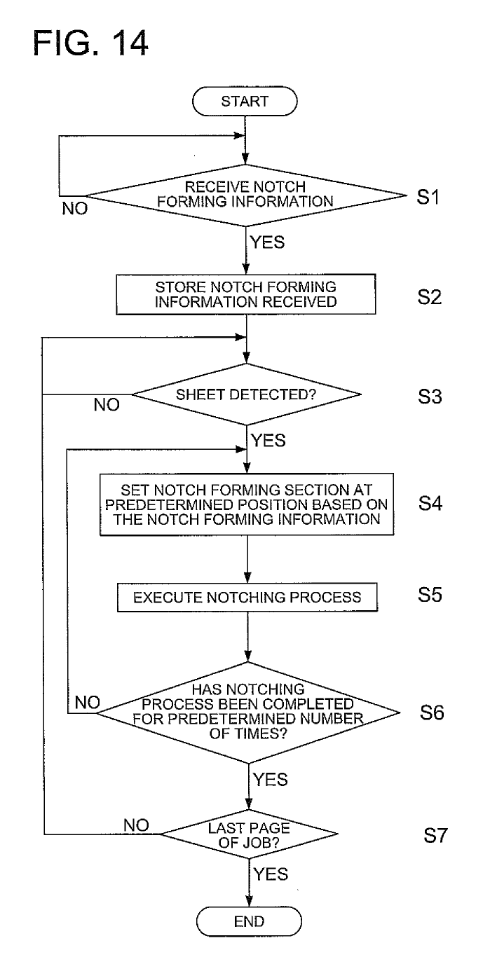

FIG. 14 is a flow chart indicating motions to form the notches V based on the number of times of the notching process and the pitch of the notch section, both of which were set by a user. The motions in FIG. 14 are motions of jobs producing one set of booklet, and the decision steps (steps S1, S3, S6, and S7) in FIG. 14 are carried out in the post-processing control section 200 in the bookbinding apparatus B.

First, information such as the number of times of the notching process is set up through the operation section 9 in the image forming apparatus A, and once an execution of a job of booklet production is initiated, a decision is made (step S1) whether the bookbinding apparatus B received notch forming information containing information such as the number of times of the notching process and the pitch between notches V from the image forming apparatus A. The above notch forming information is one that the post-processing control section 200 allows the notch forming sections 300A, 300B, 300C and 300D in the bookbinding apparatus B to operate (refer to FIG. 12).

Once a decision is made that the notch forming information is received in the bookbinding apparatus B (step S1; Yes), the notch forming information received is stored in the memory section 500 in the bookbinding apparatus B (step S2). Then, the sheet detection sensor SEN, arranged at the conveyance path a, detects whether the sheet S was conveyed or not in the bookbinding apparatus B (step S3).

Once the sheet detection sensor SEN detects that the sheet S was conveyed (step S3; Yes), the moving section 400 sets the notch forming sections 300A, 300B, 300C and 300D to predetermined positions, based on the notch forming information which was received and stored at the steps S1 and S2. Then, the notching process is carried out (step S5) for the sheet S conveyed, to form the notches V at the predetermined positions of the sheet S. The number of times of the notching process carried out is counted at a counter (not illustrated) in the bookbinding apparatus B.

Next, referring to the number of times of the notching process counted at the above counter and the notch forming information, a decision is made whether the notching process has been completed for the predetermined number of times (step S6) or not. If a decision is made that the notching process has not been completed for the predetermined number of times (step S6; No), the motions of the steps S4 and S5 are repeated, and then the notching sections V are formed on the sheet S by the notch forming sections 300A, 300B, 300C and 300D which were moved to different positions by the moving section 400 with referring to the notch forming information. In other words, the post-processing control section 200 controls motions in the bookbinding apparatus B so that the notching process is carried out for the number of times predetermined by a user.

On the other hand, if a decision is made that the notching process has been completed for the predetermined number of times (step S6; Yes), a decision is made whether the sheet S, in which the notching process has been carried out, is the last page of the job (step S7) or not, and if it is not the last page, motions from steps S3 to S6 are repeated.

As stated above, the sheet bundle Sa, which is produced by execution of a plurality of the notching processes, becomes the form as shown in FIG. 15.

FIG. 15a is an oblique perspective figure indicating the sheet bundle Sa which will be formed in case where two times notching processes are carried out, and FIG. 15b is a rear front view of the sheet bundle Sa.

As shown in FIG. 15a, the notch V is formed at an edge part of the sheet S, and a plurality of the sheets S, on each of which the notch V is formed, are bundled, whereby the notch channel Va is formed in the rear part Sb of the sheet bundle Sa.

A state of the rear part Sb of the sheet bundle Sa viewed from the X direction in FIG. 15a is shown in FIG. 15b. Since eight notches V are formed for one piece of sheet S, eight notch channels Va are formed in the rear part Sb of the sheet bundle Sa. The notch channel Va marked with diagonal lines in FIG. 15b is a notch channel constituted with the notches V formed by the first notching process, and the notch channel Va painted black in FIG. 15b is a notch channel constituted with the notches V formed by the second notching process. Further, the pitch a between the notch channel Va marked with diagonal lines and the notch channel Va painted black is regulated to become a pitch between the notches V set by a user.

To the rear part Sb of the sheet bundle Sa, in which the notch channel Va is formed, an adhesive N is applied via the coating section 50. The adhesive N enters into the notch channel Va as well as being applied to the rear part, whereby an adhesive surface is formed. By allowing the adhesive to enter into the notch channel Va formed in the rear part of the sheet bundle Sa, the attachment of the rear part of the sheet bundle Sa is enhanced, whereby it can be prevented that, when the booklet Bk made by pasting the cover sheet K is opened, sheets S with insufficient adhesion are dropped off and the booklet Bk misses pages.

As was shown in FIG. 13 to FIG. 15, by execution of a plurality of notching processes by changing positions of the notches V for one piece of sheet, when a plurality of sheets are made to be the sheet bundle Sa, many notch channels Va are formed, which enables adhesives to fully enter a place between the rear part of the sheet bundle and the front cover, whereby attachment between the sheet bundle and the front cover can be fully secured. Further, the number of notch forming sections, which forms the notch V, can be decreased to result in suppression of the size and the complexity of the bookbinding apparatus B.

[Notching Process with Referring to Pattern Information]

In FIGS. 13 to 15, the motions were explained, in which a user sets up, for example, the number of times of the notching processes through the operation section 9, and based on the setting contents, a plurality of the notching processes are carried out. While, referring to pattern information in which positions of the notches V are regulated, it is also possible to carry out a plurality of the notching processes by changing the positions of the notches V.

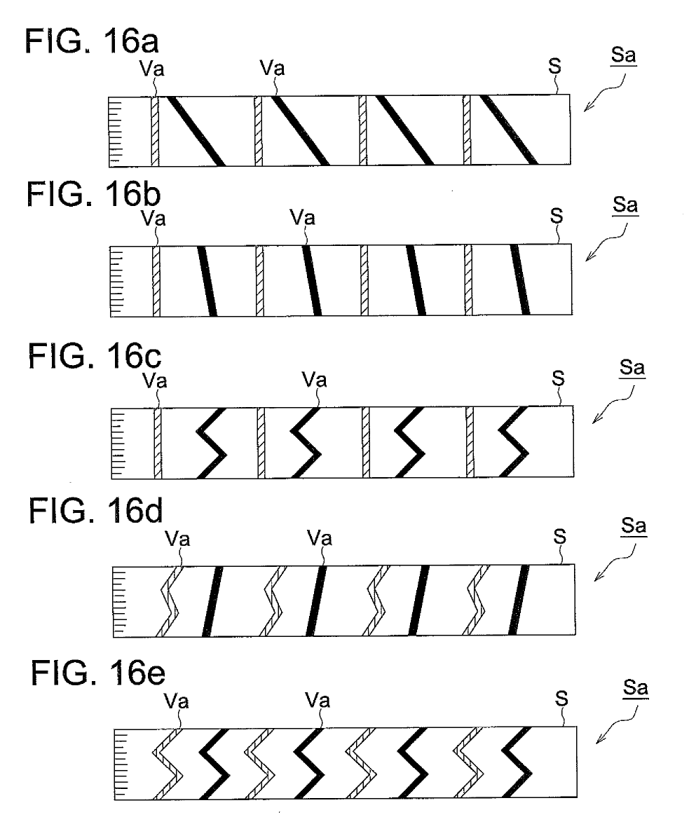

FIG. 16 is an explanatory figure showing patterns of the notch channel Va formed on the sheet bundle Sa. The bookbinding system shown in FIG. 1 has a plurality of pieces of pattern information in which positions of the notches V are regulated, and carries out multiple notching processes by changing the positions of the notches V formed in a piece of sheet. The present embodiment has five pieces of pattern information in which two times of the notching process are carried out by changing the positions of the notches V, and, when the sheet bundle Sa is formed based on the above pattern information, the notch channel Va having any one of patterns as shown in FIG. 16 is formed in the rear part of the sheet bundle Sa.

The notch channels Va marked with diagonal lines in FIG. 16 are notch channels composed of notches V formed by the first notching process, and the notch channels Va painted black are notch channels composed of notches V formed by the second notching process. Each of the patterns of the notch channel Va shown in FIG. 16 exhibits different characteristics. Each of the patterns is described below regarding the above point.

The pattern shown in FIG. 16a is a mixed one of a vertical straight line pattern and a largely inclined line pattern. Since the pattern shown in FIG. 16a has a part where positions of the notches V are horizontally out of line among sheets, attachment of sheets to each other is fully secured, whereby a sheet S is unlikely to be dropped off from a booklet produced. Further, since a vertical straight line pattern is included, a rear crack that the rear part Sb of the sheet bundle Sa is broken and cracked when the booklet is opened is also unlikely to take place. Therefore, the pattern shown in FIG. 16a is suitable for producing a booklet using coated papers, which booklet is likely to drop off the sheets S. The above pattern is also suitable for producing a booklet with a moderate number of sheets S.

The pattern shown in FIG. 16b is a mixed one of a vertical straight line pattern and a slightly inclined line pattern. The pattern shown in FIG. 16b is suitable for preventing the rear crack described above. Therefore, the pattern shown in FIG. 16b is suitable for producing a booklet with a large number of sheets, which booklet is likely to cause the rear crack. It is also suitable for producing a booklet using plain papers, in which booklet attachment of sheets to each other is readily secured.

The pattern shown in FIG. 16c is a mixed one of a vertical straight line pattern and a zigzag line pattern. The pattern shown in FIG. 16c is effective for prevention of both the rear crack and the dropping off of sheets from a booklet. Therefore, the pattern shown in FIG. 16c is suitable for producing a booklet using coated papers, which booklet is likely to drop off the sheets S. It is also suitable for producing a booklet with a large number of sheets, in which booklet the rear crack is likely to take place.

The pattern shown in FIG. 16d is a mixed one of a zigzag line pattern and a largely inclined line pattern. The pattern shown in FIG. 16d is one which basically focuses on prevention of dropping off of the sheet S from a booklet. Therefore, the pattern shown in FIG. 16d is suitable for producing a booklet using coated papers, which booklet is likely to drop off the sheets S. It is also suitable for producing a booklet with a large number of sheets, in which booklet the rear crack is likely to take place.

The pattern shown in FIG. 16e is composed only of a zigzag line pattern. The pattern shown in FIG. 16e is one which basically focuses on prevention of dropping off of the sheet S from a booklet, and, like a pattern shown in FIG. 16d, is suitable for producing a booklet using coated papers, which booklet is likely to drop off the sheets S. It is also suitable for producing a booklet with a large number of sheets, in which booklet the rear crack is likely to take place.

As explained above, each of patterns of the notch channel Va has different characteristics. Therefore, based on setting contents of a job of booklet production, the pattern information suitable for the each job is selected (decided), and a pattern of the notch channel Va is formed in the rear part of the sheet bundle Sa, based on the selected pattern information (for example, in case where a booklet, in which dropping off of the sheet S from the booklet is unlikely to take place, is desired to produce, pattern information, which can prevent the dropping off of the sheet S, is selected, whereby a notch channel Va with a predetermined pattern is formed in the rear part of the sheet bundle Sa).

Methods for selecting the pattern information of the notch position include a method for automatically selecting the pattern information based on the setting contents such as a type of the sheet S, and the number of sheets of the sheet bundle Sa per booklet, which are set up by a user, and a method for a user to directly select the pattern information when a job of booklet production is set up.

Firstly, there will be explained a method for automatically selecting the pattern information of the notch position based on the setting contents such as a type of the sheet S, and the number of sheets of the sheet bundle Sa per booklet, which are set up by a user.

Prior to execution of a job of booklet production, a user sets up contents such as the type of the sheet S, which is outputted through the operation section 9 of the image forming apparatus A. Further, in case where a bookbinding system receives a job of booklet production from an external terminal to produce a booklet, a user sets up contents such as the type of the sheet S, which is outputted through the external terminal.

The contents which are set up by a user include a type of the sheet S, a basis weight of the sheet S, the number of sheets of the sheet bundle Sa per booklet, and a thickness of a sheet bundle per booklet. In the present embodiment, when a user sets up the above contents, the suitable pattern information of the notch position is automatically selected based on the above setting contents. The main control section 100 in the image forming apparatus carries out the selection motion based on the predetermined programs, and the suitable pattern information is automatically selected, with referring to tables such as shown in Tables 1 to 4 below (the aforesaid tables are stored in the memory section 102).

Firstly, in a job of booklet production, when a user sets up the type of the sheet S through sections such as the control section 9, by referring to the table shown in Table 1 below, the pattern information of the notch position is selected so as to form a pattern of the suitable notch channel Va. In Tables 1 to 4, the pattern of the notch channel Va shown in FIG. 16a is designated as the “pattern 1”, and the pattern of the notch channel Va shown in FIG. 16b is designated as the “pattern 2”. In addition, patterns of the notch channel Va shown in FIGS. 16c, 16d, and 16e are designated as the “pattern 3”, the “pattern 4”, and the “pattern 5”, respectively.

TABLE 1

Type of Paper

| | Plain | |
|---|---|---|
| | Paper | Coated Paper |
| | Recycled | High-Quality Paper |
| | Paper | Book paper |
| Pattern 1 | | A |
| Pattern 2 | A | |
| Pattern 3 | A | |
| Pattern 4 | | A |
| Pattern 5 | | A |

Note:
“A” means applicable

As shown in Table 1, when a user selects a plain paper or a recycled paper regarding a type of the sheet S which is outputted for booklet production, the pattern information of the notching position is selected so that the pattern 2 or the pattern 3 is formed; and when a user selects a coated paper, a high-quality paper, or a bookpaper regarding a type of the sheet S, the pattern information of the notching position is selected so that one pattern among the patterns 1, 4, and 5 is formed.

When a user sets up the basis weight of the sheet S through the control section 9, with referring to the table shown in Table 2 below, the pattern information of the notch position is selected so that a suitable pattern of the notch channel Va is formed. The basis weight of the sheet S means that the weight per unit area (one square meter) of the sheet S is indicated by gram.

TABLE 2

| | Basis Weight [g/m²] | | |
|---|---|---|---|
| | 40-71 | 72-161 | 162-300 |
| Pattern 1 | | A | |
| Pattern 2 | A | | |
| Pattern 3 | | A | |
| Pattern 4 | | A | |
| Pattern 5 | | | A |

Note:
“A” means applicable

As shown in Table 2, when a user selects a sheet S of 40 to 71 g/m² in basis weight as a sheet outputted for booklet production, the pattern information of the notch position is selected so that the pattern 2 is formed. When a user selects a sheet S of 72 to 161 g/m² in basis weight as a sheet outputted for booklet production, the pattern information of the notch position is selected so that one pattern among the patterns 1, 3, and 4 is formed. Further, when a user selects a sheet S of 162 to 300 g/m² in basis weight as a sheet outputted for booklet production, the pattern information of the notch position is selected so that the pattern 5 is formed.

Further, when a user sets up the number of sheets of the sheet bundle Sa per booklet through the control section 9, with referring to the table shown in Table 3 below, the pattern information of the notch position is selected so that a suitable pattern of the notch channel Va is formed. In case where the number of sheets of the sheet bundle Sa is not set up by a user, the pattern information of the notch position may be selected in such a manner, for example, the number of sheets of an original document is counted at an automatic original document feeder DF, the number of sheets of the sheet bundle Sa is calculated based on the counted number of sheets of the original document, and a table shown in Table 3 below is referred to based on the calculated result.

TABLE 3

| | The Number of Sheets of | | |
|---|---|---|---|
| | Sheet Bundle [sheet] | | |
| | 10-69 | 70-150 | 151-300 |
| Pattern 1 | A | A | |
| Pattern 2 | | | A |
| Pattern 3 | | | A |
| Pattern 4 | | | A |
| Pattern 5 | | | A |

Note:
“A” means applicable

As shown in Table 3, in case where the number of sheets of the sheet bundle Sa, which was set up by a user, is in the range of 10 to 69, the pattern information of the notch position is selected so that the pattern 1 is formed. Also in case where the number of sheets of the sheet bundle Sa, which was set up by a user, is in the range of 70 to 150, the pattern information of the notch position is selected so that the pattern 1 is formed. While, in case where the number of sheets of the sheet bundle Sa, which was set up by a user, is in the range of 151 to 300, the pattern information of the notch position is selected so that one pattern among the patterns 2 to 5 is formed.

Further, when a user sets up a thickness of the sheet bundle Sa per booklet through the control section 9, with referring to the table shown in Table 4 below, the pattern information of the notch position is selected so that a suitable pattern of the notch channel Va is formed. In case where the thickness of the sheet bundle Sa is not set up by a user, the pattern information of the notch position may be selected in such a manner, for example, the number of sheets of an original document is counted at the automatic original document feeder DF, the thickness of the sheet bundle Sa is calculated based on the counted number of sheets of the original document, and the table shown in Table 4 below is referred to based on the calculated result.

TABLE 4

| | Thickness of Sheet | | |
|---|---|---|---|
| | Bundle [mm] | | |
| | 1.0-6.9 | 7.0-15.0 | 15.1-30.0 |
| Pattern 1 | A | A | |
| Pattern 2 | | | A |
| Pattern 3 | | | A |
| Pattern 4 | | | A |
| Pattern 5 | | | A |

Note:
“A” means applicable

As shown in Table 4, in case where the thickness of the sheet bundle Sa, which was set up by a user, is in the range of 1.0 to 6.9 mm, the pattern information of the notch position is selected so that the pattern 1 is formed. Also in case where the thickness of the sheet bundle Sa, which was set up by a user, is in the range of 7.0 to 15.0 mm, the pattern information of the notch position is selected so that the pattern 1 is formed. While, in case where the thickness of the sheet bundle Sa, which was set up by a user, is in the range of 15.1 to 30.0 mm, the pattern information of the notch position is selected so that one pattern among the patterns 2 to 5 is formed.

In case where, in one job, a user sets up the type of the sheet S, the basis weight of the sheet S, and the number of sheets of the sheet bundle Sa per booklet, the pattern information of the notch position is selected with a setting content of the type of the sheet S being priority. For example, when the type of the sheet S is sets to a plain paper, the basis weight of the sheet S is sets to 40 to 71 g/m2, and the number of sheets of the sheet bundle Sa per booklet is set to 70 to 150, the pattern information of the notch position is selected so that either the pattern 2 or the pattern 3 is formed with a setting content of the type of the sheet S being priority.

Referring to the tables of Tables 1 to 4, if a plurality of pieces of pattern information are selectable, the pattern information of the notch position is selected so that a pattern is formed with the pattern 4 preceding the pattern 5, the pattern 3 preceding the pattern 4, the pattern 2 preceding the pattern 3, and the pattern 1 preceding the pattern 2. For example, in case where the type of the sheet S is a coated paper, and other setting items are not sets up, the patterns 1, 4, and 5 are selectable based on Table 1, but the pattern information of the notch position is selected so that the pattern 1 is formed with priority.

As described above, when the pattern information of the notch position is automatically selected based on settings such as the type of the sheet S and the number of sheets of the sheet bundle Sa per booklet, which are set up by a user, a booklet in an appropriate bonding state can be produced.

Next, a method for a user to directly select the pattern information of the notch position, when a job of booklet production is set up, will be explained.

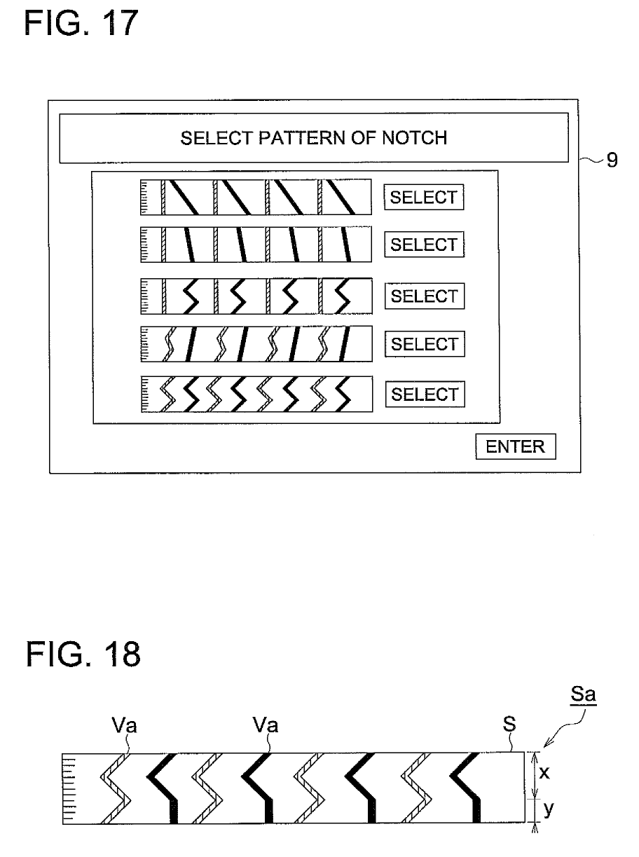

FIG. 17 is an explanatory figure of patterns of the notch channel Va displayed in the control section 9 for user's selection.

At a time of setting up a job of booklet production, the pattern information of the notch position as shown in FIG. 17, which was stored in the memory section 102, is displayed in the control section 9 as a pattern of the notch channel Va. A user takes characteristics of a booklet to be outputted into consideration, and selects any of patterns of the notch channels shown in the control section 9. In case where a user selects a pattern of the notch channel Va, the user selects the pattern by pushing a selection button which is placed lateral to pattern designs as shown in FIG. 17. It may make easier for a user to select a pattern by displaying explanatory texts of characteristics of various patterns (for example, a pattern which exhibits back crack resistant properties) along with the pattern designs.

As described above, at a time of setting up a job of booklet production, by allowing a user to directly select pattern information of a notch position, the apparatus becomes convenient.

A control motion to carry out a plurality of notching processes by changing positions of the notch V with referring to the pattern information, in which positions of the notches V are regulated, is almost similar to the flow chart shown in FIG. 14. And the bookbinding apparatus B receives the pattern information selected at the image forming apparatus A from the image forming apparatus A, and a plurality of notching processes are carried out based on the above pattern information received.

As described above, even if a plurality of notching processes are carried out for one sheet, by changing positions of the notches V, with referring to the pattern information in which positions of the notches V are regulated, many notch channels Va are formed when a sheet bundle Sa is made from many of the above sheet, whereby adhesives can be sufficiently entered into a place between the rear part of the sheet bundle and the cover sheet, resulting in attachment between the sheet bundle and the cover sheet being sufficiently secured. Further, the number of notch forming sections in which the notches V are formed can be decreased, to result in suppression of the size and the complexity of the bookbinding apparatus B.

The pattern of the notch channel Va is not limited to the five types of patterns shown in FIG. 16, and various other types of patterns can be conceived. FIG. 18 is an explanatory figure showing a pattern of the different notch channel Va formed in the sheet bundle Sa. In case where the sheet bundle Sa is composed of various kinds of papers, the notch channel Va is composed of the pattern shown in FIG. 18. In FIG. 18, the area x is the part which is composed of coated papers, and the area y is the part which is composed of plain papers. Since coated papers are likely to be dropped off from a booklet, the area x is made to be a zigzag line pattern. While, since plain papers are unlikely to be dropped off from a booklet by its nature, the area y, which is composed of the plain papers, is made to contain a straight line pattern to prevent a back crack.

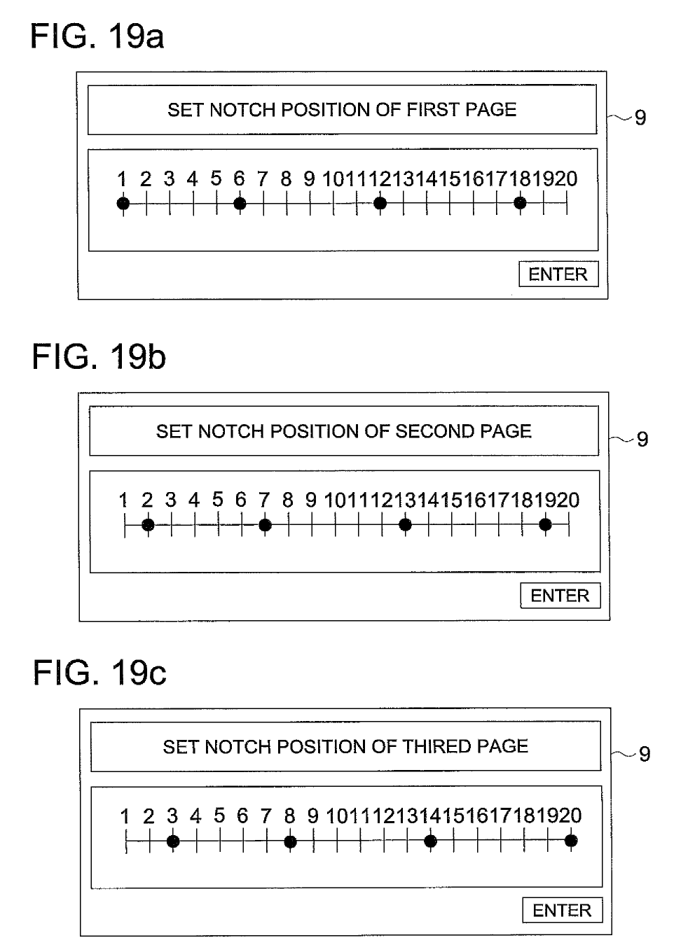

Further, not only that a user selects a pattern from pattern information of notch positions which are registered in advance in the bookbinding system, but it can be conceived that a user inputs a desired pattern of a notch channel Va to be formed through the control section 9, to form a notch channel Va using the above inputted pattern. FIG. 19 is an explanatory figure showing a setting screen inputting a pattern of a notch channel Va.

Firstly, in order to set up notch positions of the first sheet of the sheet bundle Sa as shown in FIG. 19a, the numerical parts among numerals from 1 to 20 showing notch positions in the control section 9 are selected, to determine the notch positions (the sections where numerals from 1 to 20 are arranged, corresponds to an edge part of the sheet S which forms notches V). In FIG. 19a, 1^{st}, 6^{th}, 12^{th}, and 18^{th} positions are determined to be the notch positions. Subsequently, in order to determine the notch positions of the second and the third sheets of the sheet bundle Sa, the numeral parts, among numerals from 1 to 20 showing the notch positions in the control section 9, are similarly selected, to determine the notch positions (refer to FIGS. 19b and 19c).

Thus, pattern information of notch positions is determined by setting up notch positions for each sheet of the sheet bundle Sa, and the bookbinding apparatus B forms an inputted pattern of the notch channels Va in the back portion of the sheet bundle Sa. As a result, a booklet can be produced using a pattern of a notch channel Va which meets users' demands. Pattern information of notch positions regarding a pattern of the notch channel Va inputted through a control section 9 is stored into the memory section 102 in the image forming apparatus A, after which, the above inputted pattern information becomes selectable.

[Control of Notching Process based on Conveyance Pitch of Sheet]

In case where a plurality of numbers of the notching process are carried out with positions of the notches V being changed, the sheet S is required to stop for a predetermined time at the notching section 300 during a shift of the notch forming sections 300A, 300B, 300C and 300D or execution of the notching process. But due to a fast printing speed or a short pitch of the sheet S depending on jobs to be carried out, there are some cases where the sheet S is not allowed to stop for a long time at the notching section 300. Therefore, the number of times of the notching process is controlled based on a pitch of the sheet which is conveyed by execution of the job.

In the bookbinding system shown in FIG. 1, the printing speed varies depending on the job, and there are three printing speeds of jobs to be carried out as shown in Table 5; 60 sheets/min, 70 sheets/min, and 80 sheets/min. Further, the patterns of the notch channel Va described in FIG. 16 are formed by two executions of the notching process, and since the pitch of the notch V varies from pattern to pattern, the moving time of the notch forming sections 300A, 300B, 300C and 300D differs each other. As a result, the time to carry out the two notching processes varies with each pattern. Then, in the bookbinding system, as shown in Table 5, it is determined whether the notching process of each pattern can be temporally carried out for each printing speed.

TABLE 5

| | Printing Speed | | |
|---|---|---|---|
| | [sheet/min] | | |
| | 60 | 70 | 80 |
| Pattern 1 | A | NA | NA |
| Pattern 2 | A | A | NA |
| Pattern 3 | A | A | NA |
| Pattern 4 | A | A | A |
| Pattern 5 | A | A | NA |

Note:
“A” means applicable, and
“NA” means not applicable

In Table 5, “A” means that the time for the two notching processes is sufficient for the printing speed of a job, and “NA” means that the time for the two notching processes is insufficient for the printing speed of a job. For example, for the pattern information to form the pattern 1 of the notch channel Va, in case of the printing speed of 60 sheets/min, two notching processes can be properly carried out, but, in case of the printing speed of 70 sheets/min, or 80 sheets/min, two notching processes cannot be temporally carried out.

Therefore, prior to print job execution, the bookbinding apparatus B receives the printing speed information and the pattern information of the notch position, and then, judges in the post-processing control section 200 whether two notching processes can be carried out or not using information given in Table 5. If it is judged that the two notching processes cannot be carried out, only the first notching process is set to be carried out. Alternatively, whether the printing speed may be lowered or not is selected by a user, and in case where the printing speed may be lowered, the two notching processes with the printing speed being lowered are set to be carried out.

Thus, by regulating the number of times of the notching processes based on a pitch of sheet conveyance, the notching process with the proper number of times can be carried out considering outputting speed of a sheet.

[Control of Notch Depth]

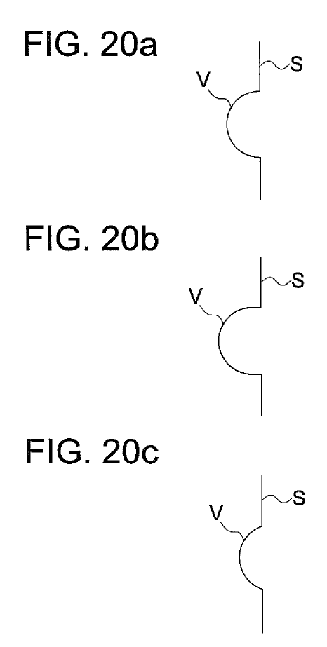

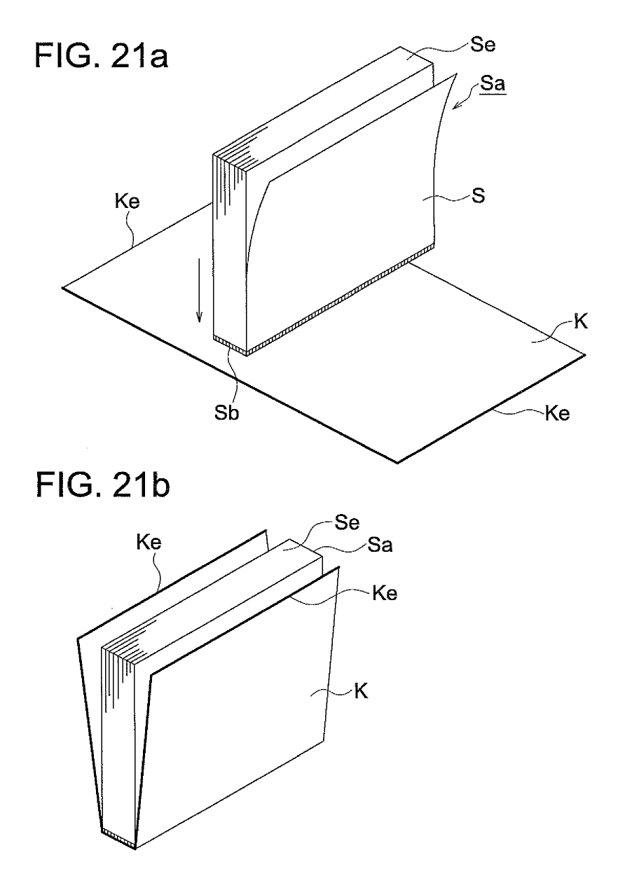

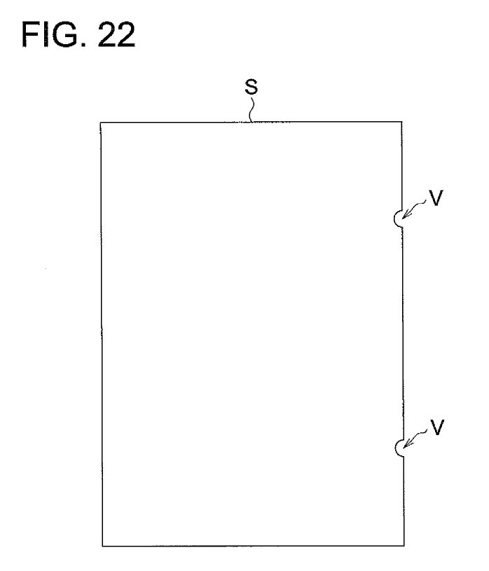

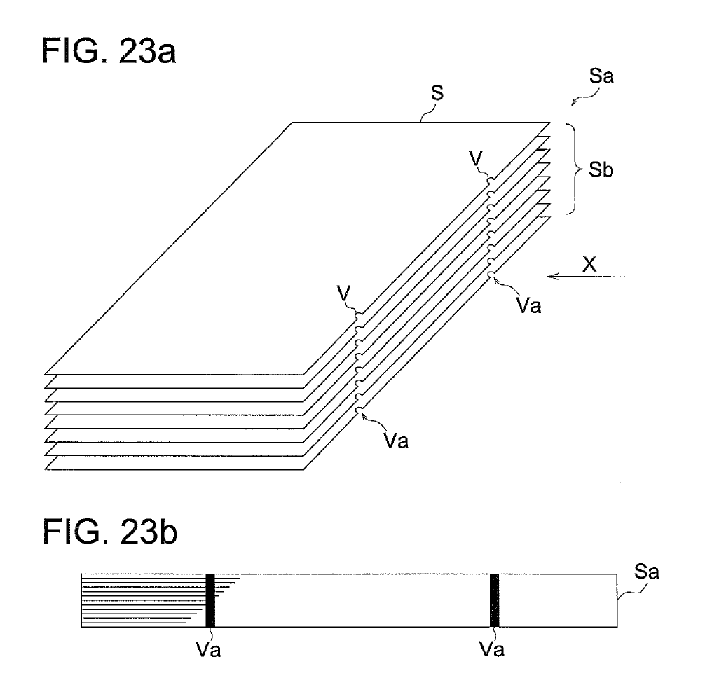

FIG. 20 is an explanatory figure showing the notches V having different depth.

The depth of the notch V formed at an edge part of the sheet S is made to be adjustable, and the notch V shown in FIG. 20a is one having a regular depth. In case where the notch V is regulated by ways such as settings by a user, the stop position of the sheet S against the notch forming sections 300A, 300B, 300C and 300D is regulated.

In case of strengthening attachment between the sheet bundle and the cover sheet, the notch V is made deeper as shown in FIG. 20b so that more adhesive is entered into the notch V. While, in case of weakening attachment between the sheet bundle and the cover sheet, the notch V is made shallower as shown in FIG. 20c so that adhesive is not so much entered into the notch V. In case where a plurality of notching processes are carried out, each process may be carried out so that the notch V has the same depth, or the notch V has different depth.

Since the depth of the notch V can be thus regulated, the attachment between a sheet bundle and a cover sheet can be regulated, whereby a booklet which meets users' demands can be produced.

The present invention is not limited to the above embodiments and various changes and modification may be made without departing from the scope of the invention.

In the present embodiment, the notches V forming motions are controlled by the post-control section 200 in the bookbinding apparatus B, but the main control section 100 in the image forming apparatus A may control the notches V forming motions.

An apparatus C, having a notch forming apparatus, differing from the image forming apparatus A and the bookbinding apparatus B, may have a notch control section.

In a constitution shown in FIG. 12, the notch forming sections 300A, 300B, 300C and 300D are moved against the sheet S by the moving section 400, but positions of the notches V may be moved by moving the sheet S against the notch forming sections 300A, 300B, 300C and 300D.

Each of the notch forming sections 300A, 300B, 300C and 300D shown in FIG. 12 is separated from each other, but there may be taken a configuration that the above notch forming sections are integrated into one section and a plurality of punches are provided in the above integrated notch forming section.

In the bookbinding system shown in FIG. 1, each of the image forming apparatus A and the bookbinding apparatus B is separated from each other, but there may be taken a configuration that the above two apparatuses are integrated into one.

What is claimed is:

1. A notch forming apparatus, comprising:
a notch forming section to form a notch on an edge section of a sheet configuring a sheet bundle outputted by executing a job;
a moving section to move a position of the notch to be formed by the notch forming section on the sheet; and
a control section to control at least the notch forming section and the moving section for performing multiple notch forming operation while moving the notch position in respect to one sheet.

2. The notch forming apparatus of claim 1, wherein number of times of notch forming operation is regulated based on setting contents of the job to be executed.

3. The notch forming apparatus of claim 1, wherein a distance between notches formed on one sheet is regulated based on setting contents of the job to be executed.

4. The notch forming apparatus of claim 1, wherein the control section controls at least the moving section with reference to pattern information defining the position of the notch determined based on setting contents of the job to be executed.

5. The notch forming apparatus of claim 1, wherein the control section regulates number of times of the notch forming operation based on a conveyance interval of the sheet conveyed by executing the job.

6. The notch forming apparatus of claim 1, wherein the control section regulates a depth of the notch formed by the notch forming section.

7. A bookbinding apparatus, comprising:
the notch forming apparatus of claim 1; and
a bookbinding section to form the sheet bundle by accumulating sheets on which notches are formed by the notch forming apparatus and to form a booklet by bonding an edge section of the sheet bundle with an adhesive, wherein the notches are formed on the edge section.

8. A bookbinding system, comprising:
an image forming apparatus to form an image on the sheet; and
the bookbinding apparatus of claim 7 to perform bookbinding using the sheets on which images are formed by the image forming apparatus.
